(19) United States
(12) Patent Application Publication
(10) Pub. No.: US 2016/0180223 A9
(43) Pub. Date: Jun. 23, 2016

(54) METHOD AND APPARATUS FOR IMPLEMENTING NEUROSCIENCE IN GROUP DECISIONS

(71) Applicant: John Muller, West Hartford, CT (US)

(72) Inventor: John Muller, West Hartford, CT (US)

(73) Assignee: ACADEMIC KEYS LLC, Storrs, CT (US)

(21) Appl. No.: 14/177,675

(22) Filed: Feb. 11, 2014

Related U.S. Application Data
(60) Provisional application No. 61/793,734, filed on Mar. 15, 2013.

(51) Int. Cl. G06N 5/04

(52) U.S. Cl. CPC G06N 5/04

(57) ABSTRACT

Human decision-making is enhanced by defining decision criteria, then presenting data responsive to the criteria in a manner that is optimized based on the neuroscience of human information processing. For example, data is displayed in a uniform format along with a list of criteria; data responsive to a selected criterion is highlighted as hot data; and a scoring window is displayed for a user to score the conformance of the hot data to the selected criterion.

### CROSS REFERENCE TO RELATED APPLICATIONS

The present application is a non-provisional of U.S. App. 61/793,734, filed Mar. 15, 2013, which is hereby incorporated by reference in its entirety.

### BACKGROUND

1. Technical Field

The present invention relates to computer-aided decision-making. Particular embodiments of the invention relate to computer systems configured to mitigate cognitive biases that impair decision-making.

2. Discussion of Art

An ever increasing body of research, based in fMRI (functional MRI brain scanning), reveals that a powerful and pervasive array of subconscious inputs and actions (collectively, “cognitive biases”) control human data handling and decision-making. Thus, particularly in a group context, decisions customarily are made subconsciously and emotionally—typically without reference to logically established rules for “what is best,” sometimes without reference to the data on which the decisions ostensibly are based.

Key principles suggested by the recent research include the following.

There are limits on the amount of concepts/choices that can be processed by the conscious mind. Also, conscious reflection is a slow and uncertain (“deliberative”) process. On the other hand, subconscious processing is very fast and certain. Thus, decisions first are made subconsciously. Whether a decision-maker then will consciously vet or review the decision, depends on characteristics (e.g., importance, urgency, novelty, and complexity) of the data in which the decision is situated. The term “situated” is chosen because, as the quantity and quality of data become larger and more complex, decisions increasingly are not based in the data, but only are made in context of the data.

Increased quantities and complexities of data tend to divorce decision-making from the bulk of the data, because when processing limits of the human mind are exceeded it wanders or become uneasy, and resorts to unconscious rules or heuristics. Procrastination is a common heuristic: when overloaded, the mind subconsciously decides to defer decisions. A large (overloading) amount of data for the human mind is relatively small. Five concepts/choices is a typical acceptable load. Beyond five, most minds overload into a distress state in which the decision maker is emotionally labile and has heightened sensitivity to social, physical, and emotional threat cues in preference to rational analysis. Thus, the human mind is exceptionally poor at rational decision-making when given any more than five or six options to consider. Instead, when confronted with large amounts of data, a typical decision maker accesses subconscious rules or heuristics to prioritize and process the data quickly, not accurately, so as to exit from the distress state and restore a sense of calm. Such heuristics often assess expected outcomes based only on how exceptional data interacts with the subconscious heuristics. One very common heuristic for prioritizing excess data, is to passively defer a decision until the variables are reduced by externalities. Another common heuristic is to take an action that immediately diminishes the quantity of data relevant to the decision.

Attention span, also, is limited. Studies show an average attention span is about twenty minutes. Anything longer and the mind wanders. Any data given during this time is not processed or remembered. Instead, “wander thoughts” displace relevant data. Wander thoughts, like distress thoughts, typically are motivated by social, emotional, and physical cues extraneous to the data that is logically connected with a decision.

To summarize, when faced with confusing or excessive data that makes a decision difficult, humans become uneasy. The decision is physically uncomfortable. To rapidly reduce the discomfort, humans unconsciously create heuristics. Thus, unstructured data and large amounts of data cause creation of subliminal heuristics. Studies have shown these rules have little or no correlation with the original intent of decision-making, but that the mind instead tends to focus unduly on a few primitive cues.

For example, when a person is given a document (e.g., a curriculum vita) along with criteria to assess the document, there are countless options. What is the context? Is there any relative importance? Does the score on one criterion affect the score on another? Is one more important than another? Taking just three criteria, there are six possible mental arrangements but no clear choice, so the odds of choosing a “correct” decision are 1/6. The number of options rise rapidly; for four, the odds are 1 in 24, for six the options go to 720. These odds also assume there is clarity in the options. If there is ambiguity in the information as to which parts of the document pertain to a particular criterion, the possibilities rise rapidly. This is why the mind makes up subconscious heuristics. It has to reduce the odds to make a decision.

The cognitive, conscious mind is not aware of this activity. Instead, the conscious mind creates artificial and usually unrelated reasons for the decisions motivated by primitives. Later conscious rationalizations do not correlate with the rules developed and applied subconsciously. Thus, a decision maker who has operated in distress will continue to experience uncertainly and uneasiness each time they assess the decision they have made. This discomfort continues even or perhaps especially if data is available to completely invalidate the rationalized bases for the decision. Instead of adjusting the decision to integrate the conflicting data, the mind will focus on rationalizing away the conflicting data. Thus, decisions made in distress become difficult to change.

In a group decision, humans are very uncomfortable going against their group. Each individual human decision maker is simultaneously a member of several groups, and the particular context of decision-making will determine with which group the individual aligns.

Accordingly, participants in a typical group decision will assume one of four archetypal roles.

A first role is that of the initiator: This person usually has a stronger personality or is has a higher-level position than the others. In fact, the person speaking first is subconsciously viewed as the leader. This subconscious bias is so strong that, in numerous studies, even if the initiator proposes a wrong answer and an individual knows the answer is wrong, he/she will go along with the group 74% to 97% of the time.

A second role is that of a blocker, who challenges the initiator. The blocker will be of equal or similar stature as the initiator. The blocker champions different choices and refutes the ideas of the initiator.

Initiators and blockers dominate the meeting, and rarely reach accord. In fact, the longer the discussion, the more entrenched each becomes.

A third role is that of the supporter(s), who will side with either the initiator or the blocker primarily in response to their assessments of emotional status and physical/social dominance.

A fourth role is that of an observer, who maintains neutrality, tending to merely observe and give comment while not supporting either side. The observer(s) will assent to the supporter(s) decision. Their comments typically are not incorporated into the decision.

This power play scenario typically leads to a decision, made by the supporters and ratified by the observers, that expresses the relative status and personal charisma of the initiator and the blocker(s), without reference to the ostensible priorities intended to be the basis of the decision. Typically, only the “winning” initiator or blocker feels satisfied, while everyone else experiences cognitive dissonance between the rationalization and the actual basis of the decision; this likely is why most people find meetings disagreeable and a waste of time.

### BRIEF DESCRIPTION

According to certain embodiments of the present invention, rational criteria for decision-making are established and prioritized, before data or options are presented. Options then are identified. Based on the established criteria and priorities, data are tallied and ranked for each identified option.

These and other objects, features and advantages of the present invention will become apparent in light of the detailed description thereof, as illustrated in the accompanying drawings.

### DRAWINGS

FIG. 1 shows steps and operands of a method according to a first embodiment of the invention.

FIG. 2 illustrates a presentation of data according to the method as shown in FIG. 1.

### DETAILED DESCRIPTION OF THE DRAWINGS

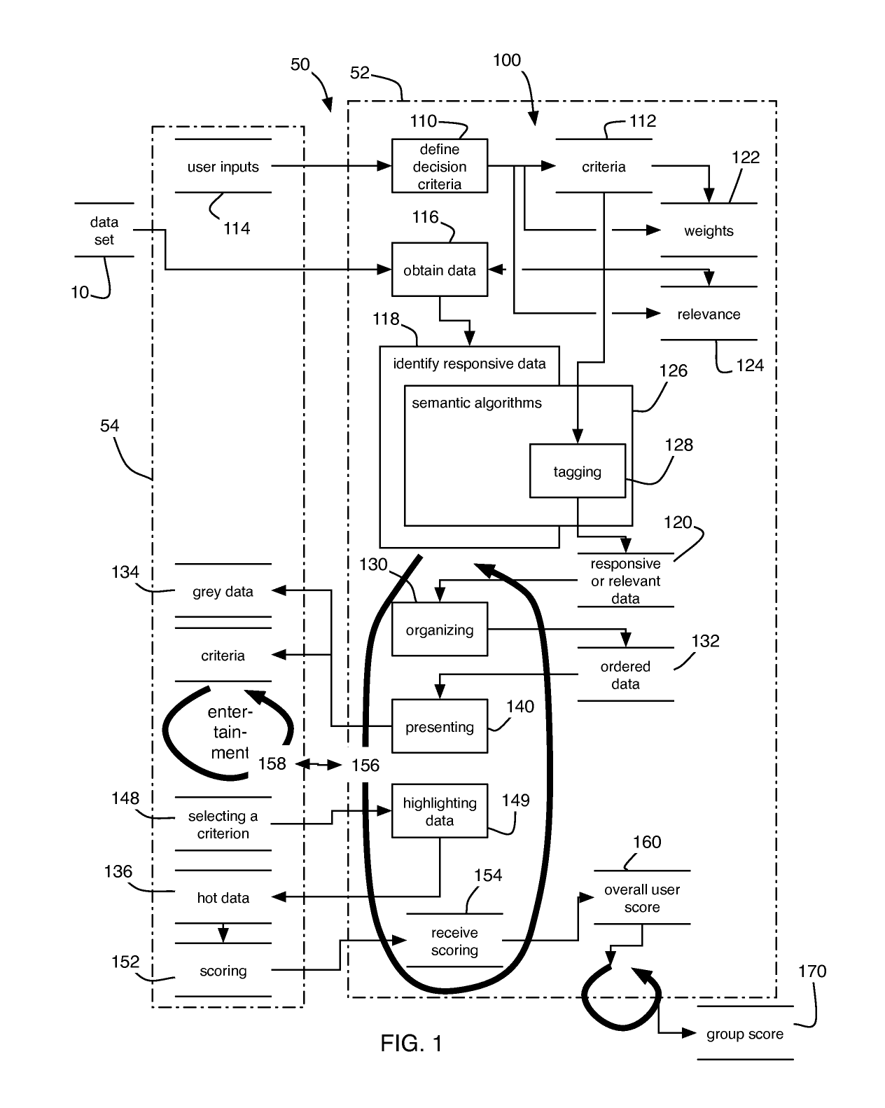

Referring to FIG. 1, an exemplary embodiment of the invention utilizes a computer interface 50 (i.e. a processor 52 and input/output device(s) 54) to implement a method 100 for enhancing human decision-making. The processor 52 may be any conventional computing device (e.g., a RISC, an ASIC, an FPGA, a Pentium or x86-series processor or look-alike), while the input/output device 54 may be any one or more of a touchscreen, a keyboard, a touchpad, a non-touch monitor, a haptic (Braille) text interface, a mouse, a joystick, or the like. The method 100 includes several sub-processes, which are accomplished primarily by the processor 52, although certain steps are implemented via the input/output device(s) 54.

First, defining 110 decision criteria 112 based on user inputs 114 about the decision to be made; then, obtaining 116 a data set 10 and identifying 118 data 120 responsive to the criteria within the data set 10. Thus, the user(s) enter(s) inputs 114 that inform the criteria 112 and define the knowledge sought for the data 120, the weighting 122 of each criterion, if any, and the time or contextual relevance 124 of the criteria. In some embodiments, the criteria 112 are used to search 116 for potentially relevant information 120 within the domain of public data (e.g. on the open internet), thereby obtaining the data set 10; in other embodiments, the criteria are used to identify relevant data 120 within a pre-supplied set of data 10 (e.g. within a proprietary network or database, possibly within a subset of folders, files, or records). For example, semantic algorithms 126 may be used to parse and filter data, assigning or “tagging” 128 each element of a data set 10 as being relevant data 120 for none or more of the criteria 112. In certain embodiments, the semantic algorithms 126 may rely upon a user-defined dictionary. On the other hand, certain algorithms may use web-scraping techniques to accumulate an algorithmic dictionary of terms potentially relevant to the user-defined criteria 112.

Second, organizing 130 available data 120 based on its relevancy to the defined criteria, in order to mitigate or leverage cognitive biases related to ordering, anchoring, overload, contextual filtering, etc. Generally, the human mind gauges the value of ordered data 132 based on the narrative structure of its presentation. People typically presume that the first data presented is the most important data. Ordering data from the most to the least relevant aligns the data's perceived value to the previously established criteria. This standard biases all subsequent interpretation, keeping the mind more focused on the most important factors as these factors are presented early and with higher frequency.

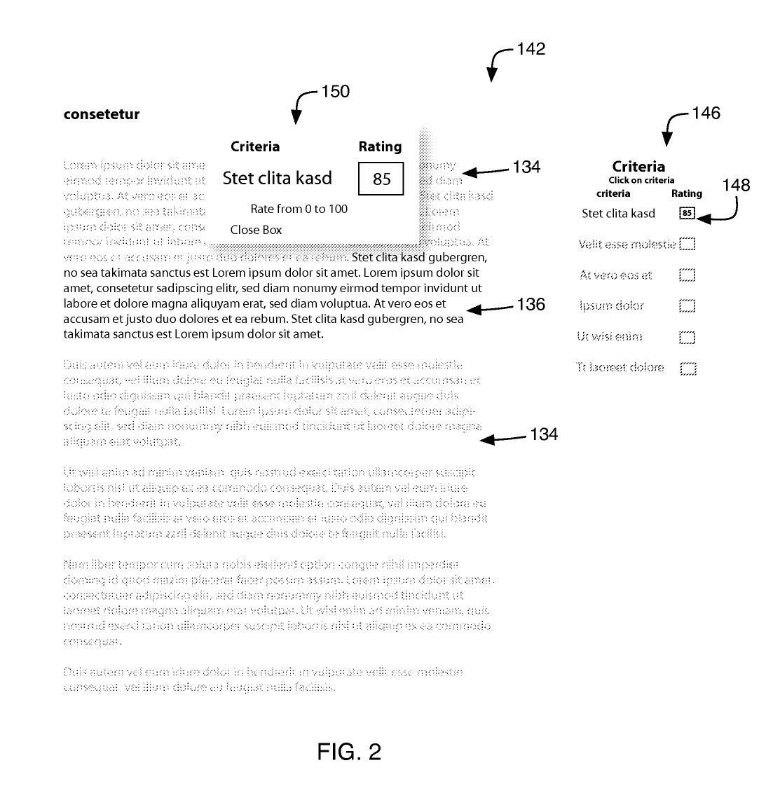

Third, presenting 140 the ordered data 132 in a way that focuses attention on smaller, usually very small quanta of data while also situating the small quanta of data within a larger context. For example, FIG. 2 illustrates a presentation 142 in which text format is standardized and unrelated data is removed, as formatting, font, and semantic context will influence perceptions of the relevant data. Tests have demonstrated that font size and typeface strongly influence the perceived complexity of the data. Data presented using large san serif fonts are perceived as more understandable and less complex. Additionally, anchoring is a process the mind uses to establish value and importance based on context. As one example, an artist's name, their employer, even knowledge of where they went to school, may anchor a decision-maker's subconscious perception of the value of the artist's work product. Stripping away extraneous data enhances direct comparison of relevant data (e.g. a commercial illustration) to pre-established standards (e.g. clarity, brightness, contrast, subject).

More particularly, FIG. 2 shows ordered data 132 displayed in a main window 144 with a listing 146 of criteria 112 at the right side. This presentation accords with eye-tracking studies that indicate English-reading users tend to fixate on the left hand side of a printed page. Referring also to FIG. 1, all the ordered data 132 remains greyed out (grey data 134) until a user selects 148 a criterion 112, at which time data relevant to the selected criterion is highlighted 149 (to be displayed as hot data 136), while data not relevant to the selected criterion remains grayed out. Also in response to selecting 148 a criterion, a scoring window 150 is displayed for user scoring 152 of how well the hot data 136 conforms to its criterion 112. The system receives 154 the user scoring of the hot data, then continues in this manner until each criterion is scored, or (in certain embodiments) until a pre-defined task time 156 expires. In embodiments utilizing the task time, then in case the task time expires, the user scoring is saved, and the data display is temporarily replaced (during a relaxation interval 158) by non-interactive content (e.g., audiovisual entertainment) or by interactive content unrelated to the task of scoring data (e.g., a video game). After the relaxation interval expires, then the presentation again is displayed. Once all data and criteria have been scored, then the scores are aggregated to obtain an overall user score 160 of the data set 10 relative to the criteria 112.

This process 100 then is repeated for each of a plurality of users in order to obtain an overall group score 170 of the data set 10, relative to the criteria 112.

The process 100 also is repeated for multiple data sets 10, in order to obtain a plurality of overall group scores each corresponding to one of the data sets. Based on the plurality of overall group scores, the users then can identify a preferred data set for further use.

According to some embodiments, a criterion previously identified as highest priority is at the top of the list and is first to be auto-selected and highlighted. When the reader has scored the highlighted data, the next criterion then is selected and highlighted in decreasing order of priority. This structured approach reinforces the ordering of data as discussed above.

In certain embodiments, presentation of data is limited to a “process window” of fifteen minutes or less, thereby giving a margin within the average attention span of twenty minutes. By carefully controlling the amount and complexity of data presented, the mind is kept focused and underwhelmed. It can process data easily, make more precise judgments and hence better decisions.

Advantageously, a structured presentation, which emphasizes data in discrete and timely chunks that are related only to selected criteria, holds the decision-maker's attention on the relevant data. Few variables are considered in scoring each chunk of the data. The paucity of variables makes scoring physiologically and psychologically easier. Each chunk of data is considered in view of a single explicitly presented rule, the criterion. The decision-maker is not required to recall or to select which rule they are meant to apply to a particular chunk of data. Further, because the highlighted data all is related to a single concept or choice, and the scoring is relative to a rule that is explicitly presented adjacent the highlighted data, scoring is an entirely conscious act. There is no need to create subconscious heuristics.

Thus, breaking the information down and grouping the information into subgroups based on the criteria helps maintain attention and focuses and reduces the reader's decision making information to the subset. By redirecting the focus to a single criteria and presenting information pertaining on to the criteria, the user makes better choices because of the reduced information and the singular focus. This focus increases accuracy and confidence, the reason for reduced subconscious dissonance.

By presenting the information pertaining only to single criterion, choices are greatly reduced. Dissonance is further reduced by ranking on a scale. Humans are much more comfortable using a scale because, unlike a binary decision, of right or wrong, a scale is a gradient between right or wrong. This is a much more acceptable option for humans. Further, by sub categorizing each criterion then aggregating the total score for all criteria, the scorer becomes more comfortable with or else resigned to the final result—the process of accumulating an aggregate score, over several steps, psychologically distances the scorer from the initial state of uncertainty and thereby either bolsters confidence in the outcome based on labor invested, or instills a sense of “sunk cost” that the scorer does not want to waste, or both.

Part four utilizes scientific evidence of group dynamics to facilitate productive group interaction and consensus decisions making by groups. Briefly, the “Law of Crowds” states while no one person's score is accurate, the average of many individual and independent scores will be accurate. In the case of small groups, the overall accuracy increases according to the number of criteria considered. By pre-scoring or prioritizing the criteria prior to scoring the data, the ranking and the decision of the best options already has been decided by the group. Since these scores are the result of each member's individual scores, there is a strong urge to accept them. The inventive system presents the aggregate scores as the group's best unbiased consensus, arrived at prior to a meeting to ratify the scores. Thus there is no need for an “initiator” or a “blocker” in discussion of the scores.

The consensus imposed a priori by this methodology is very, very dominant. To argue against an aggregate score is to argue against the group, and humans are loathe to go against a “tribal” decision. What's more, they will have tendency to act unconsciously to sustain the group decision. Each member of the group instinctively recognizes that other members will resent “blocking” behavior and will subconsciously work to oust or punish a blocking member. Hence, the power inherent in the method.

By contrast, without starting from aggregate scores, there is a need for at least an initiator to establish group direction toward comparison of individual scores. That conventional dynamic of score comparison starts off with each member challenging every other member's scores and methodology. Under the conventional methodology, not only does each member arrive to a meeting with uncertainty regarding their own scoring, they have additional uncertainty around the scores and methods of other members. The inventive method and system obviate this source of group tension and thereby enhance group confidence.

Although exemplary embodiments of the invention have been described with reference to appended drawings, those skilled in the art will apprehend various changes in form and detail consistent with the scope of the invention as defined by the appended claims.

What is claimed is:

1. A system for enhancing human decision-making, comprising
a. an input/output device; and
b. a processor configured to:
i. receive user inputs from the input/output device regarding the decision to be made;
ii. define decision criteria based on the user inputs;
iii. identify data responsive to the user inputs;
iv. organize the responsive data;
v. present the organized data via the input/output device;
vi. receive user scoring of the presented data from the input/output device; and
vii. accumulate an overall user score.

2. The system as claimed in claim 1, wherein organizing the responsive data includes ordering the responsive data according to the weight of at least one criterion to which each datum is tagged as responsive.

3. The system as claimed in claim 1, wherein presenting the responsive data includes displaying the responsive data at the input/output device in uniform format as grey data.

4. The system as claimed in claim 3, wherein presenting the responsive data further includes displaying a subset of responsive data at the input/output device as hot data, in response to a selection of a criterion made via the input/output device.

5. The system as claimed in claim 1, wherein presenting the responsive data includes displaying the responsive data at the input/output device adjacent to a list of the criteria.

6. The system as claimed in claim 5, wherein presenting the responsive data further includes displaying a scoring window at the input/output device adjacent to the responsive data, in response to a user selection of a criterion from the list of the criteria.

7. The system as claimed in claim 1, wherein presenting the responsive data includes after expiration of a task time, displaying entertainment at the input/output device until expiration of a relaxation interval, then again presenting the responsive data at the input/output device.

8. The system as claimed in claim 1, wherein identifying responsive data includes using a semantic algorithm for tagging data as responsive to one or more of the criteria, according to a dictionary defined at least in part by user inputs.

9. A method for enhancing human decision-making, comprising:
a. receiving user inputs regarding a decision to be made;
b. defining decision criteria based on the user inputs;
c. identifying data responsive to the user inputs;
d. organizing the responsive data;
e. presenting the organized data;
f. receiving user scoring of the presented data; and
g. accumulating an overall user score.

10. The method as claimed in claim 9, wherein organizing the responsive data includes ordering the responsive data according to the weight of at least one criterion to which each datum is tagged as responsive.

11. The method as claimed in claim 9, wherein presenting the responsive data includes displaying the responsive data at the input/output device in uniform format as grey data.

12. The method as claimed in claim 11, wherein presenting the responsive data further includes displaying a subset of responsive data at the input/output device as hot data, in response to a selection of a criterion made via the input/output device.

13. The method as claimed in claim 9, wherein presenting the responsive data includes displaying the responsive data at the input/output device adjacent to a list of the criteria.

14. The method as claimed in claim 13, wherein presenting the responsive data further includes displaying a scoring window at the input/output device adjacent to the responsive data, in response to a user selection of a criterion from the list of the criteria.

15. The method as claimed in claim 9, wherein presenting the responsive data includes after expiration of a task time, displaying entertainment at the input/output device until expiration of a relaxation interval, then again presenting the responsive data at the input/output device.

16. The method as claimed in claim 9, wherein identifying responsive data includes using a semantic algorithm for tagging data as responsive to one or more of the criteria, according to a dictionary defined at least in part by user inputs.
